(19) United States
(12) Patent Application Publication
(10) Pub. No.: US 2021/0213605 A1
(43) Pub. Date: Jul. 15, 2021

(54) ROBOT CONTROL UNIT AND METHOD FOR CONTROLLING A ROBOT

(71) Applicant: Robert Bosch GmbH, Stuttgart (DE)

(72) Inventor: Volker Fischer, Renningen (DE)

(21) Appl. No.: 17/066,928

(22) Filed: Oct. 9, 2020

(30) Foreign Application Priority Data
Jan. 9, 2020 (DE) 102020200165.0

(51) Int. Cl. B25J 9/16; G06N 3/08

(52) U.S. Cl. CPC B25J 9/161; B25J 9/06; G06N 3/08; B25J 9/163

(57) ABSTRACT

A robot control unit for a multi-jointed robot including multiple concatenated robot links. The robot control unit includes a plurality of recurrent neural networks, an input layer, which is configured to feed to each recurrent neural network a respective piece of movement information for a respective robot link, each recurrent neural network being trained to ascertain and output based on the movement information fed to it a position state of the respective robot link, and a neural control network, which is trained to ascertain control variables for the robot links based on the position states output by the recurrent neural networks and fed as input variables to the neural control network.

### CROSS REFERENCE

The present application claims the benefit under 35 U.S.C. § 119 of German Patent Application No. DE 102020200165.0 filed on Jan. 9, 2020, which is expressly incorporated herein by reference in its entirety.

### BACKGROUND INFORMATION

Different exemplary embodiments relate in general to robot control units and methods for controlling a robot.

Manipulation tasks are important in many ways, for example, in production facilities. In such case, it is a basic task to move a manipulator (for example, a gripper) of a robot into a predefined target state. The robot in this case is made up of a series of linked joints having various degrees of freedom (DoF). There are various approaches to solving this problem.

One possibility for controlling generally autonomous systems are neural networks based on reinforcement learning methods, which may also be used for controlling multi-jointed robot methods. Explicit coordinate systems (for example, Cartesian or spherical coordinates) are usually used in the case of robot control for describing the spatial system states.

The paper “Vector-based navigation using grid-like representations in artificial agents,” Nature, 2018, by A. Banino et al. describes the application of biologically motivated neural networks, which use so-called place cells and grid cells in order to represent spatial coordinates for solving navigation problems.

### SUMMARY

A problem underlying the present invention is to provide an efficient control of a multi-jointed robot with the aid of a neural network.

Example embodiments of the robot control unit and the robot control method in accordance with the present invention may enable an improved calculation of a control signal for a multi-jointed physical system (for example, a robot including a gripper or a manipulator) with the aid of a neural network (i.e., the performance of the control with the aid of a neural network). This may be achieved by using a network architecture that generates a grid coding (GC) for position states and thus a representation for spatial coordinates useful for neural networks.

Different exemplary embodiments of the present invention are described below.

Exemplary embodiment 1 is a robot control unit for a multi-jointed robot including multiple concatenated robotic links having a plurality of recurrent neural networks, an input layer, which is configured to feed to each recurrent neural network a respective piece of movement information for a respective robot link, each recurrent neural network being trained to ascertain and output a position state of the respective robot link based on the movement information fed to it, and a neural control network, which is trained to ascertain control variables for the robot links based on the position states output by the recurrent neural networks and on the position states fed as input variables to the neural control network.

Exemplary embodiment 2 is a robot control unit according to exemplary embodiment 1, each recurrent neural network being trained to ascertain the position state in a grid coding representation and the neural control network being trained to process the position states in the grid coding representation.

Grid codings are advantageous for path integration of states and represent a metric (distance measure) also for large distances (large in relation to the maximum grid size). In general, the representation of spatial states as grid coding is more advantageous than the direct (for example, Cartesian representation) coordinate representation in order to be further processed by a neural network.

Exemplary embodiment 3 is a robot control unit according to exemplary embodiment 1 or 2, each recurrent neural network including a set of neural grid cells and each recurrent neural network and the respective set of grid cells being trained in such a way that the closer the ascertained position state of the respective robot link of the grid is to grid points, the more active each grid cell is for a spatial grid associated with the grid cell.

Exemplary embodiment 4 is a robot control unit according to exemplary embodiment 3, for each recurrent neural network, the set of neural grid cells including a plurality of grid cells, which are associated with spatially differently oriented grids.

Multiple grid cells associated with spatially differently oriented grids enable a position state (for example, a position in the space) to be clearly indicated.

Exemplary embodiment 5 is a robot control unit according to one of the exemplary embodiments 1 through 4, the recurrent neural networks being long short-term memory networks and/or gated recurrent unit networks.

Such types of recurrent networks enable the efficient generation of grid codings of position states.

Exemplary embodiment 6 is a robot control unit according to one of the exemplary embodiments 1 through 5, the plurality of recurrent neural networks including a recurrent neural network, which is trained to ascertain and to output a position state of an end effector of the robot control unit and including at least one recurrent neural network, which is trained to ascertain and to output a position state of an intermediate link, which is situated between a base of the robot and the end effector of the robot.

This enables an efficient control, in particular, for multi-jointed robots of this type, for example, robot arms.

Exemplary embodiment 7 is a robot control unit according to one of the exemplary embodiments 1 through 6, including a neural position ascertainment network that contains the multiple recurrent neural networks and includes an output layer, which is configured to ascertain a deviation of the position states of the robot links output by the recurrent neural networks from respective admissible ranges for the position states, and the neural control network being trained to further ascertain the control variables from the deviation fed to it as an input variable.

In this way, physical system requirements and limitations may be formulated as a loss based on the estimated position states and provided as additional inputs to the control network. This makes it possible for the control network to take the system requirements thus formulated into account during the implementation.

Exemplary embodiment 8 is a robot control method including ascertaining control variables for the robot links using a robot control unit according to one of the exemplary embodiments 1 through 7 and controlling actuators of the robot links using the ascertained control variables.

Exemplary embodiment 9 is a training method for a robot control unit according to one of the exemplary embodiments 1 through 7, including training each recurrent neural network for ascertaining a position state of a respective robot link from movement information for the robot link; and training the control network for ascertaining control variables from the position states fed to it.

Exemplary embodiment 10 is a training method according to exemplary embodiment 9, including training the control network by reinforcement learning, a reward for ascertained control variables being reduced by a loss, which penalizes a deviation of position states of the robot links resulting from the control variables from respective admissible ranges for the position states.

In this way, physical system requirements and limitations may be formulated as a loss based on the estimated position states and provided as additional inputs to the control network during the training. This enables the control network to take the system requirements thus formulated into account during its training, so that during a later implementation (i.e., during the robot control for a specific task) the control network generates control commands that conform to the admissible position state ranges.

Exemplary embodiment 11 is a computer program, including program instructions which, when they are executed by one or multiple processors, prompt the one or multiple processors to carry out a method according to one of the exemplary embodiments 8 through 10.

Exemplary embodiment 12 is a computer-readable memory medium, on which program instructions are stored which, when they are executed on one or multiple processors, prompt the one or multiple processors to carry out a method according to one of the exemplary embodiments 8 through 10.

### BRIEF DESCRIPTION OF THE DRAWINGS

Exemplary embodiments of the present invention are depicted in the figures and are explained in greater detail below. In the figures, identical reference numerals refer in general to the same parts everywhere in the multiple views. The figures are not necessarily true to scale, the focus instead being generally on the representation of the features of the present invention.

FIG. 1 shows a robot assembly.

FIG. 2 schematically shows an example of a multi-jointed robot including multiple concatenated robot links.

FIG. 3 schematically shows a representation of a neural network in cooperation with a neural control network for a robot.

FIG. 4 schematically shows a representation of the behavior of a grid cell and a place cell.

FIG. 5 shows the architecture of a control model according to one specific embodiment.

FIG. 6 shows a robot control unit for a multi-jointed robot including multiple concatenated robot links according to one specific embodiment.

### DETAILED DESCRIPTION OF EXAMPLE EMBODIMENTS

The different specific embodiments, in particular, the exemplary embodiments described below, may be implemented with the aid of one or multiple circuits. In one specific embodiment, a “circuit may be understood to mean any type of logic-implemented entity, which may be hardware, software, firmware or a combination thereof. Thus, in one specific embodiment, a “circuit” may be a hardwired logic circuit or a programmable logic circuit such as, for example, a programmable processor, for example, a microprocessor. A “circuit” may also be software, which is implemented or executed by a processor, for example, any type of computer program. Any other type of implementation of the respective functions, which are described in greater detail below, may be understood as a “circuit” in accordance with one alternatively specific embodiment.

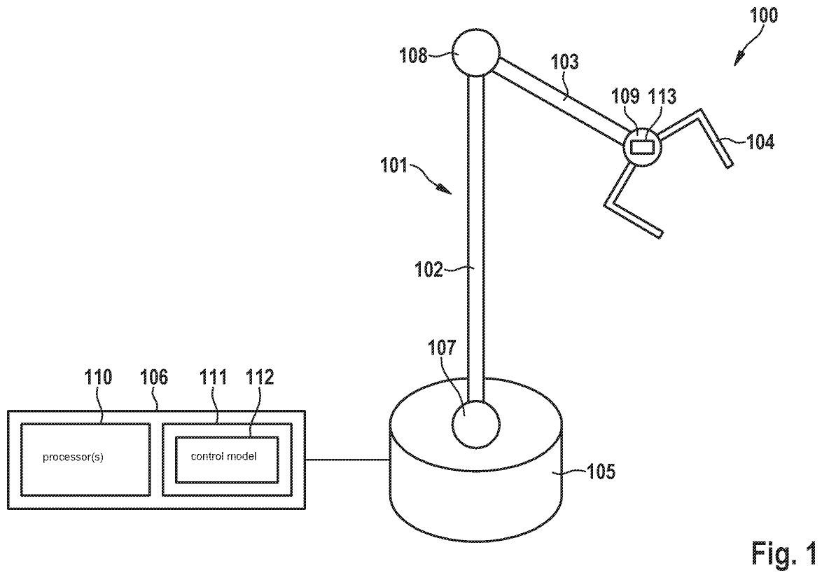

FIG. 1 shows a robot assembly 100.

Robot assembly 100 includes a robot 101, for example, an industrial robot in the form of a robot arm for moving, mounting or machining a workpiece. Robot 101 includes robot links 102, 103, 104 and a base (or, in general, a holder) 105, by which robot links 102, 103, 104 are supported. The term “robot link” refers to the movable parts of robot 101, the actuation of which enables a physical interaction with the surroundings, for example, in order to carry out a task. Robot assembly 100 includes a control unit 106 for controlling, which is configured to implement the interaction with the surroundings according to a control program. The last link 104 (as viewed from base 105) of robot links 102, 103, 104 is also referred to as an end effector 104 and may form a manipulator, which contains one or multiple tools such as a welding torch, a gripper tool (gripper), a painting device or the like.

The other robot links 102, 103 (closer to base 105) may form a positioning device so that, together with end effector 104, a robot arm (or joint arm) is provided at its end with end effector 104. These other robot links 102, 103 form intermediate links of robot 101 (i.e., links between base 105 and end effector 104). The robot arm in this case is a mechanical arm, which is able to fulfill functions in a manner similar to a human arm (possibly including a tool at its end).

Robot 101 may include connecting elements 107, 108, 109, which connect robot links 102, 103, 104 to one another and to base 105. A connecting element 107, 108, 109 may include one or multiple joints, of which each is able to provide a rotational movement and/or a translational movement (i.e., a displacement) for associated robot links relative to one another. The movement of robot links 102, 103, 104 may be initiated with the aid of actuators, which are controlled by control unit 106.

The term “actuator” may be understood to be a component that is suitable, in response to its being driven, to influence a mechanism, and is also referred to as an actuator. The actuator is able to convert instructions (the so-called activation) output by control unit 106 into mechanical movements. The actuator, for example, an electromechanical converter, may be configured to convert electrical energy into mechanical energy in response to its activation.

The term “control unit” (also simply referred to as “controller”) may be understood to mean any type of logic implementation unit, which may include a circuit and/or a processor capable of executing software, firmware or a combination thereof stored in a memory medium and is able to issue the instructions, for example, to an actuator in the present example. The controller may be configured, for example, by program code (for example, software) to control the operation of a system, in the present example, a robot.

In the present example, control unit 106 includes one or multiple processors 110 and a memory 111, which stores code and data, on the basis of which processor 110 controls robot 101. According to different specific embodiments, control unit 106 controls robot 101 on the basis of an ML (machine learning) control model 112 stored in memory 111.

A control unit 106 may represent the positions of the robot links (or equivalent thereto, the positions of the respective joints or actuators), for example, using Cartesian coordinates or spherical coordinates. According to different specific embodiments, instead of such a standard coordinate representation (for example, in Cartesian coordinates or spherical coordinates) for the positions of the robot links (or equivalent thereto, the joint states) of a robot 101, a so-called grid coding (GC) is used, for example, for the relative robot link positions (i.e., for example, the position of one robot link in relation to a preceding robot link, i.e., in relation to a robot link closer to base 105) and also for the actual state of the robot to be instantaneously adjusted. A position of a robot link and of the joint state (or joint position) of the robot link (which determines the position of the robot link, if necessary, as a function of additional robot links between the robot link and base 105), are summarized below under the term “position state” of the robot link.

The grid coding is particularly advantageous in conjunction with neural networks and permits an accurate and efficient planning of trajectories. According to different specific embodiments, the grid coding is generated by a neural network (NN) and serves a second neural network controlled by the robot as input, which describes the instantaneous spatial robot states (i.e., position states of the robot links).

According to different specific embodiments, such a grid coding is applied to concatenated coordinate states or system states in order, for example, to describe the state of a multi-jointed robot arm and to enable the accurate and efficient control thereof. Specific embodiments thus include an extension of a grid coding to concatenated systems.

According to different specific embodiments, system requirements of the physical system (for example, limitations in the mobility, the controllability or of the state of certain joints of the robot) are also formulated as a loss (cost term) of the estimated system states (robot position states) and provided to control unit 106 during the training of ML model 112 and also to the implementation phase as one or multiple additional reward terms or inputs. The cost term represents, for example, a deviation of estimated position states of the robot links from respective admissible ranges for the position states of the robot links.

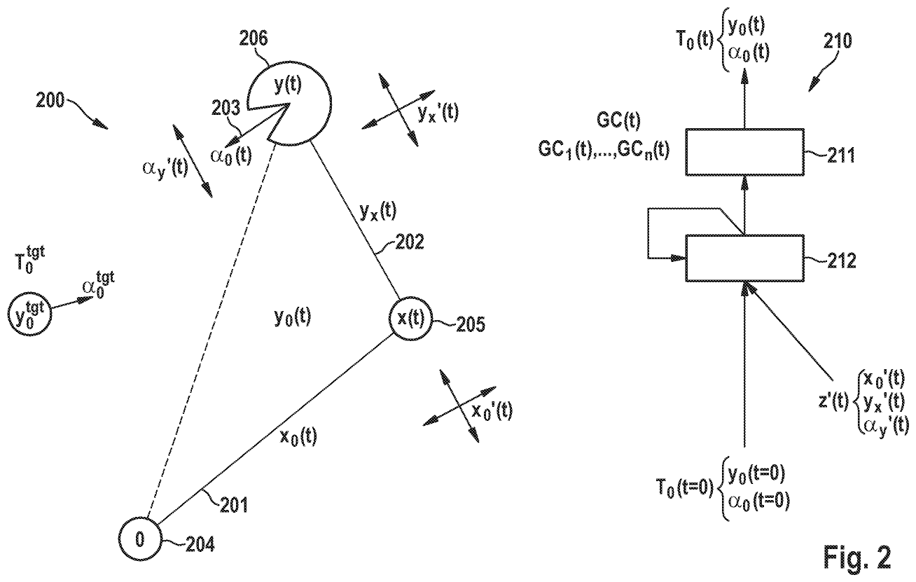

FIG. 2 schematically shows an example of a robot 200.

Robot 200 includes a base corresponding to base 105, including a base joint 204, which determines the position of a first robot link 201 (corresponding to robot link 102).

Robot 200 further includes a second robot link 202 and an end effector (depicted only as arrow 203), corresponding to robot links 103, 104. First robot link 201 is connected to second robot link 202 with the aid of an arm joint 205, the position of which is identified with x, and which determines the position of second robot link 202 relative to first robot link 201. Second robot link 202 is connected to end effector 203 with the aid of an end effector joint 206, the position of which is identified with y. The positions of joints 204, 205, 206 may also be considered to be positions of robot links 201, 202.

End effector 203 has, depending on the position of end effector joint 206, a state (for example, gripper-orientation), which is identified by α_{y}.

The control task (for example, for controller 105) consists of, for example, reaching a target state Tₒ^{tgt} (for example, tₒ^{tgt}=(yₒ^{tgt}, αₒ^{tgt})) from an initial state Tₒ (t=0), i.e., Tₒ(t)=Tₒ^{tgt} after a time t.

One example of an ML model 210 (for example, corresponding to ML model 112) for such a control task is depicted to the right in FIG. 2: a neural LSTM (long short-term memory) network 211 learns to estimate an instantaneous grid coding (GC(t)=(GC₁(t), . . . , GCₙ(t)) by integration of the input speeds z′ (t) after a certain initial state Tₒ(t=0). Based on this grid coding, which is fed to a linear layer 211, the instantaneous actual state (in the form of actual coordinates) Tₒ(t) in the origin coordinate system o is then estimated, in the process a one-hot coding of the respective value range is used for each output (for example by a place cell for a position yₒ(t) or analogously, an orientation cell for gripper orientation αₒ(t)).

Examples of system requirements, which may be taken into account with the aid of a loss in the training or also in the implementation phase are in the example of FIG. 2 for example:
Opening angle α_{y} of the gripper relative to second joint 206 is limited

Requirement: α_{y} ∈[αₘᵢₙ′αₘₐₓ]

Loss term L^{condition}: measures the degree of violation of the requirement, for example:

L^{condition}|=_{y}−(αₘᵢₙ+αₘₐₓ)/2|

−exp (|α_{y}−(αₘᵢₙ+αₘₐₓ)/2)
The angle between robot links 201 and 202 is limited. For this purpose, a loss term L^{condition} may be similarly formulated.

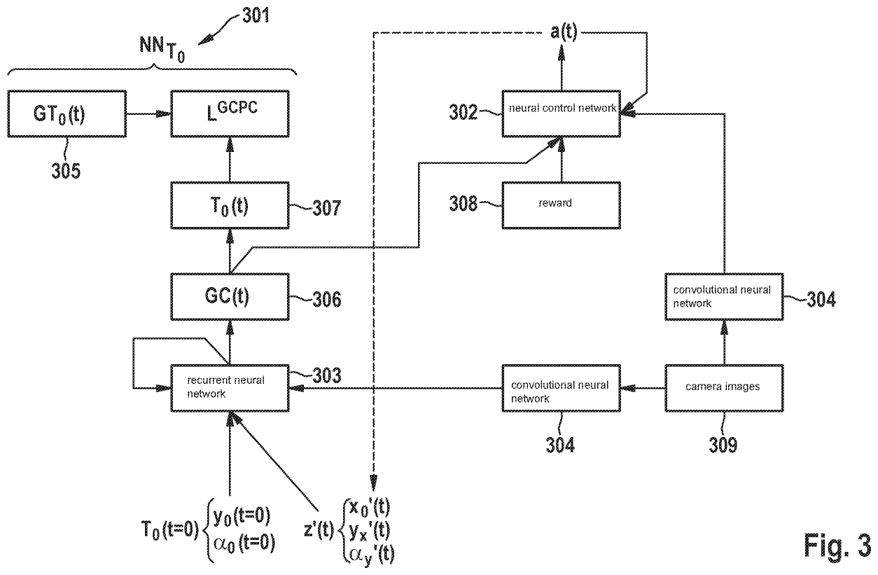

FIG. 3 schematically shows a representation of a neural network NN_{To} 301 (for example, corresponding to network 210 in FIG. 2) in cooperation with an exemplary neural control network (control-NN) 302 which, for example, is intended to control a robot arm with the instantaneous motor command a(t). For example, a reinforcement learning (RL) approach with a reward 308 may be used in order to train control network 302 (for example, an LSTM referred to as policy-LSTM). Neural network 301 includes a recurrent neural network 303 generating a position state in grid coding 306.

In order to train recurrent neural network 301, a classification loss L^{GCPC}, for example, L^{GCPC}=cross entropy (Tₒ(t), GTₒ(t)), is used, which determines the error between instantaneously estimated actual state Tₒ(t) and the actual instantaneous actual state GTₒ(t). The estimated actual state and actual actual state (i.e., the “ground truth”) 305 are represented in this case with the aid of one-hot coding (for example, the actual coordinates or the reference coordinates), thus, here a classification loss is also used and the estimated actual state Tₒ(t) may be considered as a distribution across the possible actual states. The estimated actual state (instantaneous position state) Tₒ(t) in this case is represented, for example, by a layer 307 including place cells and/or orientation cells, to which grid coding 306 is fed.

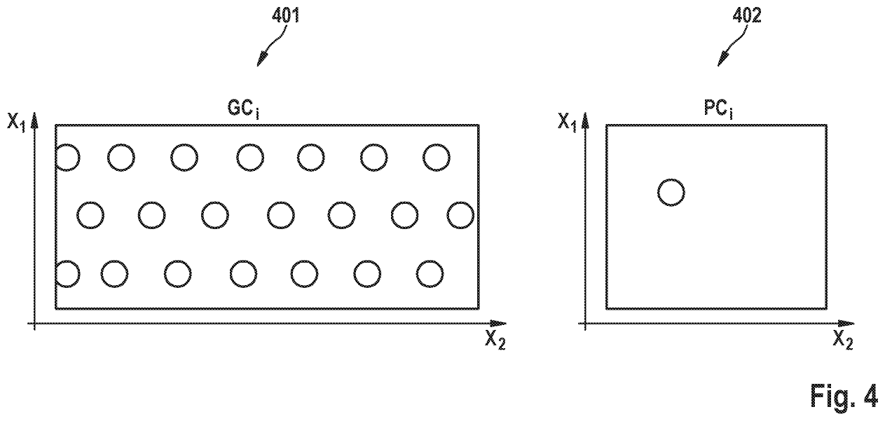

FIG. 4 schematically shows a representation of the behavior of a grid cell 401 and a place cell 402. Grid cell GCᵢ is active (high activation and correspondingly, for example, high output value) at the bright points in the state space or coordinate space (for example, x₁, x₂), which are the grid points of a grid associated with the grid cell. A grid coding, for example, of a position in space, may then be reached by an entire set of grid cells GC₁, . . . , GCₙ, which are associated with various grids (for example, various scales, various spatial offsets).

So-called border cells may also appear, which are active if a spatial boundary is present at a particular distance and orientation. A particular state or position in space, given by values (for example, space coordinates or state coordinates (x₁, x₂) or (x₁, x₂, x₃)) is then represented by a particular total activation of all grid cells. Place cell PCᵢ is active only for coordinates close to a particular state. The coordinate space may be subdivided into classes with the aid of place cells.

During the execution phase (i.e., the control phase), neural network 210, 303 estimates instantaneous global state Tₒ(t) based on the instantaneous state changes (for example, speeds) of system z′(t) and an initial state Tₒ(t=0). This results in a grid coding GC(t) due to the architecture of network 210, 310 used (with recurrent LSTM network 211, 303). These grid codings are then used as input for (recurrent) neural control network 302 (not shown in FIG. 2), which determines therefrom and from an internal memory state (for example, the previous motor command) the next control signal (motor command or set of motor commands) a(t) for the multi-jointed system (for example, robots 101, 200). Neural control network 302 may also obtain the previous action (the previous control command) as an input variable.

Network 303 generating the grid coding and control network 302 may also receive inputs from additional neural networks, for example, convolutional networks 304, which process additional inputs 30 such as, for example, camera images 304.

Every spatial coordinate representation (for example, x(t) or GC(t) below is provided with an index coordinate (for example xₒ(t) or GCₒ(t)), which specifies the reference coordinate system. For example, two different reference systems x and o are used for joint position y:

yₒ(t)=yₓ(t)+xₒ(t)

The grid coding of the actual state in the origin coordinate system is identified below with Tₒ(t). The network, which generates Tₒ(t) (neural network 210 in FIG. 2 and neural network 303 in FIG. 3) is identified with NN_{To}.

Different architectures may be used for neural network NN_{To}, for example, the architecture provided in the aforementioned paper “Vector-based navigation using grid-like representations in artificial agents.” In this case, different hyper-parameters of this architecture such as, for example, the number of the memory units used in the LSTM network, may influence the performance of NN_{To}. Thus, according to one specific embodiment, an architecture search is carried out in each case, which selects the hyper-parameters for the respective present task.

According to different exemplary embodiments, a one-hot coding of the task of NN_{To} is used: the estimation of the instantaneous actual state Tₒ(t) is represented similarly to the classification networks as so-called one-hot coding. In this case the coordinate space to be represented is uniquely divided into local (cohesive) regions, which are assigned to a class (see place cells behavior in FIG. 4). A detailed description of this one-hot coding is also to be found in the above-mentioned publication. One possible division of the coordinate space to be represented is, for example, a grid representation or a representation by random points.

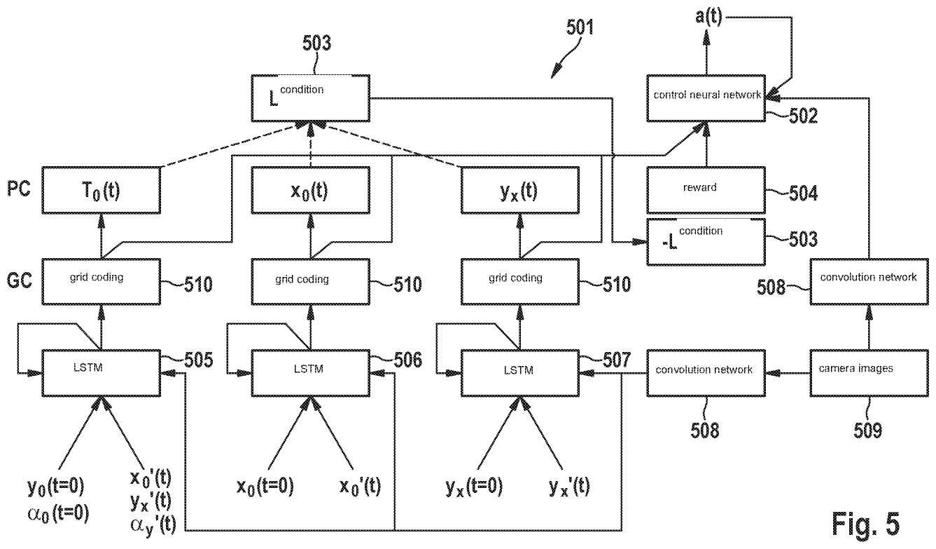

According to different specific embodiments, the grid coding for multi-jointed systems is extended insofar as in addition to instantaneous actual state Tₒ(t), additional instantaneous (for example, implicit) system states are estimated in parallel and are represented with the aid of grid coding, as is the case in the example described below with reference to FIG. 5, for example, yₓ(t).

FIG. 5 shows the architecture of a control model 500.

Control model 500 corresponds, for example, to control model 112. In this control model, not only are a grid coding of the actual state Tₒ(t) to be controlled (as in FIG. 2 and FIG. 3), but also the grid coding of the intermediate joint states (here, for example, xₒ(t) and yₓ(t)) estimated by a first neural network 501 and used as input for a second neural network 502 (control network, for example, an LSTM referred to as a policy LSTM). Accordingly, first neural network 501 includes three LSTMs 505, 506, 507 (or generally multiple recurrent neural sub-networks), one LSTM 505 thereof corresponding to network NN_{To}, which estimates the actual state and the two other LSTMs 506, 507 estimate states xₒ(t) and yₓ(t).

Physical system conditions (system requirements), for example, may also be formulated as a loss (here, for example, L^{condition} 503) and may be used as an additional (for example, second) term for reward 504 (i.e., the reward for a reinforcement learning training of the control network), in order to be taken into account by control network 502. A first term of reward 504 reflects, for example, how well the robot executed the task (for example, how closely the end effector approaches a desired target object and assumes a desired orientation).

Loss L^{condition} 503 is not necessarily used in order to train network 505 generating the grid coding, but is used, for example, in order to train control network 502 so that this network also takes system requirements into account.

For the sake of clarity, the three classification losses for training networks 505 generating the individual grid coding are not represented in FIG. 5. Each of the three networks 505 generating grid coding is trained, for example, with the aid of a classification loss similar to L^{GCPC} in FIG. 3.

Networks 505, 506, 507 for estimating the instantaneous system-internal actual states (xₒ(t) and yₓ(t)) are treated and trained similarly to NN_{To}. To train control model 500, these networks 505, 506, 507 generating grid code are initially used. For this purpose, trajectories of the system, for example, of the entire robot, are sampled, taking the system requirements into consideration, for example a trajectory suitable to the robot schematically represented in FIG. 2:

Start state: xₒ(t=0), yₓ(t=0), α_{y}(t=0)

Speed sequence: (x′ₒ(t), y′ₓ(t), α′_{y}(t)) for t=0, . . . , T.

Virtual or simulated data may also be used for this purpose. The system states to be estimated (outputs of networks 505, 506, 507, which generate the position states in grid coding 510) are converted to a corresponding one-hot encoding with the aid of a selected space classification into classes (see one-hot encoding as described above), which is then used during the training as a reference (ground truth) (for ascertaining cost term L^{PCGC} as shown in FIG. 3). A conventional optimization method (for example, RMSPROP, SGC, ADAM) may be used for the training.

Grid code-generating networks 505, 506, 507 are thus trained and generate for an input trajectory (with start state and result of speeds) the learned integrated grid codings GC of the estimated instantaneous system states.

Control network 502 may be designed and trained in different ways. One possible variant is a modification of an RL method for learning a navigation task to a multi-jointed manipulation task by replacing the target state of the navigation with the target state of the robot (for example, Tₒ(t) in FIG. 5). Reward 504 may be adapted accordingly (for example, reward as a function of the proximity to the target position and deviation of target orientation of the gripper).

In addition, known system requirements (for example, physical limitations of the system) may be represented in cost terms, which are determined on the basis of the estimated instantaneous (implicit) system states. The additional estimated (implicit) system states (for example yₓ(t) and α_{y} (t) in FIG. 5) are provided as input to control network 502. These cost terms may be taken into account as additional reward terms during the training of control network 502 and mean that violations of the system requirements result in a smaller reward and thereby teach control network 502 to take the system requirements proactively into account.

Grid code-generating networks 505, 506, 507 and the control network may also receive inputs from additional neural networks, for example, from convolutional networks 508, which process additional inputs such as, for example, camera images 509.

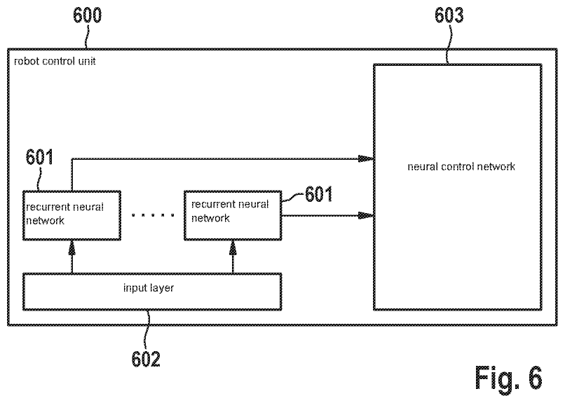

In summary, a robot control unit according to different specific embodiments is provided, as is depicted in FIG. 6.

FIG. 6 shows a robot control unit 600 for a multi-jointed robot including multiple concatenated robot links according to one specific embodiment.

Robot control unit 600 includes a plurality of recurrent neural networks 601 and an input layer 602, which is configured to feed to each recurrent neural network a respective piece of movement information for a respective robot link.

Each recurrent neural network is trained to ascertain and output based on the piece of movement information fed to it, a position state of the respective robot link.

Robot control unit 600 further includes a neural control network 603, which is trained to ascertain control variables for the robot links based on the position states output by the recurrent neural networks and fed as input variables to the neural control network.

In other words, according to different specific embodiments, position states (positions, joint states such as joint angle or joint positions, end effector states such as degree of opening of a gripper, etc.) of multiple robot links are ascertained (i.e., estimated) with the aid of respective recurrent neural networks. The recurrent neural networks according to one specific embodiment are trained in such a way that they output the estimated position states in the form of a grid coding. For this purpose, the output nodes (neurons) of the recurrent neural networks need not have any particular structure, the output of the position states in the form of grid coding on the other hand result via a corresponding training.

“Robot” may be understood to mean any physical system (including a mechanical part whose movement is controlled), such as a computer-controlled machine, a vehicle, a household appliance, a power tool, a manufacturing machine, a personal assistant or an access control system.

Although the present invention has been shown and described, primarily with reference to particular specific embodiments, it should be understood by those familiar with the field that numerous changes regarding design and details may be carried out by the present invention without departing from the essence and scope of the present invention.

What is claimed is:

1. A robot control unit for a multi-jointed robot including multiple concatenated robot links, the robot control unit comprising:
a plurality of recurrent neural networks;
an input layer, which is configured to feed to each of the recurrent neural networks a respective piece of movement information for a respective one of the robot links, each of the recurrent neural networks being trained to ascertain and output, based on the respective piece of movement information fed to it, a position state of the respective robot link; and
a neural control network, which is trained to ascertain control variables for the robot links based on the position states output by the recurrent neural networks and fed as input variables to the neural control network.

2. The robot control unit as recited in claim 1, wherein each of the recurrent neural networks is trained to ascertain the position state in a grid-coding representation and the neural control network is trained to process the position states in the grid coding representation.

3. The robot control unit as recited in claim 2, wherein each of the recurrent neural networks includes a set of neural grid cells and each of the recurrent neural networks and the respective set of grid cells are trained in such a way that the closer the ascertained position state of the respective robot link is to grid points of a grid, the more active each grid cell is for a spatial grid associated with the grid cell.

4. The robot control unit as recited in claim 3, wherein for each of the recurrent neural networks, the set of neural grid cells includes a plurality of grid cells, which are associated with spatially differently oriented grids.

5. The robot control unit as recited in claim 1, wherein the recurrent neural networks are long short-term memory networks and/or gated recurrent unit networks.

6. The robot control unit as recited in claim 1, wherein the plurality of recurrent neural networks includes a recurrent neural network, which is trained to ascertain and output a position state of an end effector of the robot control unit and includes at least one recurrent neural network, which is trained to ascertain and output a position state of an intermediate link, which is situated between a base of the robot and the end effector of the robot.

7. The robot control unit as recited in claim 1, further comprising:
a neural position ascertainment network that includes the multiple recurrent neural networks and an output layer, which is configured to ascertain a deviation of the position states of the robot links output by the recurrent neural networks from respective admissible ranges for the position states, and the neural control network being trained to further ascertain the control variables based on the deviation fed to it as an input variable.

8. A robot control method, comprising the following steps:
ascertaining control variables for a multi-jointed robot including multiple concatenated robot links using a robot control unit, the robot control unit including a plurality of recurrent neural networks, an input layer, which is configured to feed to each of the recurrent neural networks a respective piece of movement information for a respective one of the robot links, each of the recurrent neural networks being trained to ascertain and output, based on the respective piece of movement information fed to it, a position state of the respective robot link, and a neural control network, which is trained to ascertain the control variables for the robot links based on the position states output by the recurrent neural networks and fed as input variables to the neural control network; and
controlling actuators of the robot links using the ascertained control variables.

9. A training method for a robot control unit which controls a multi-jointed robot including multiple concatenated robot links, the robot control unit including a plurality of recurrent neural networks, an input layer, which is configured to feed to each of the recurrent neural networks a respective piece of movement information for a respective one of the robot links, and a neural control network, the method comprising:
training each of the recurrent neural networks to ascertain a position state of a respective robot link based on respective piece of movement information for the respective robot link; and
training the neural control network to ascertain control variables based on the position states fed to it by the recurrent neural networks.

10. The training method as recited in claim 9, wherein the control network is trained by reinforcement learning, a reward for ascertained control variables being reduced by a loss, which penalizes a deviation of position states of the robot links resulting from the control variables from respective admissible ranges for the position states.

11. A non-transitory computer-readable memory medium on which are stored program instructions, the program instructions, when executed by one or more processors, causing the one or more processors to perform the following steps:
ascertaining control variables for a multi-jointed robot including multiple concatenated robot links using a robot control unit, the robot control unit including a plurality of recurrent neural networks, an input layer, which is configured to feed to each of the recurrent neural networks a respective piece of movement information for a respective one of the robot links, each of the recurrent neural networks being trained to ascertain and output, based on the respective piece of movement information fed to it, a position state of the respective robot link, and a neural control network, which is trained to ascertain the control variables for the robot links based on the position states output by the recurrent neural networks and fed as input variables to the neural control network; and
controlling actuators of the robot links using the ascertained control variables.

12. A non-transitory computer-readable memory medium on which are stored program instructions for training a robot control unit which controls a multi-jointed robot including multiple concatenated robot links, the robot control unit including a plurality of recurrent neural networks, an input layer, which is configured to feed to each of the recurrent neural networks a respective piece of movement information for a respective one of the robot links, and a neural control network, the program instructions, when executed by one or more processors, causing the one or more processors to perform the following steps:
training each of the recurrent neural networks to ascertain a position state of a respective robot link based on respective piece of movement information for the respective robot link; and
training the neural control network to ascertain control variables based on the position states fed to it by the recurrent neural networks.
